(19) United States
(12) Patent Application Publication
(10) Pub. No.: US 2016/0125728 A1
(43) Pub. Date: May 5, 2016

(54) PATIENT ALARM SYSTEM AND DEVICE THEREFOR

(71) Applicant: Hills Limited, Sydney NSW (AU)

(72) Inventors: Alexander William Walker, Henley Beach SA (AU); Robert William White, Athelstone SA (AU); Daniel Weiss, Mount Barker SA (AU); Peter Collin Schumacher, Bridgewater SA (AU); Daniel McLean, North Adelaide SA (AU); Martin Howard Priestman Freney, Ironbank SA (AU); Stephen Geoffrey Brown, Greensborough VIC (AU); Timothy John Hooper, North Willoughby NSW (AU)

(21) Appl. No.: 14/926,318

(22) Filed: Oct. 29, 2015

(30) Foreign Application Priority Data
Oct. 30, 2014 (AU) 2014904360

(51) Int. Cl. G08B 25/12; G08B 25/01

(52) U.S. Cl. CPC G08B 25/12; G08B 25/016

(57) ABSTRACT

An activation device for a patient alarm system. The activation device comprises a resiliently deformable bladder defining an internal volume and a pressure switch in fluid communication with the internal volume and connected to an alarm system. Squeezing the resiliently deformable bladder operates the pressure switch, which activates the alarm system.

### TECHNICAL FIELD

The present invention generally relates to a system and a device for prompting healthcare personnel or carers to attend a user. In particular, the invention relates to such a system and device for prompting care of elderly users, or users with limited manual dexterity.

### BACKGROUND TO THE INVENTION

Patient alarm systems (also known as nurse call systems) are used to prompt healthcare personnel, such as doctors and nurses, or care workers, to attend to the care of a user. For example, patient alarm systems are often used in aged care homes to enable an elderly user to activate an alert when the user requires assistance from a carer, for example, assistance to use the bathroom.

A patient alarm system typically comprises a plurality of personal activation devices, each device generally being a hardwired handset secured to a fixed location in a user's room or ward or a wireless pendant secured on a lanyard around a user's neck or on a wrist, which are integrated to an alarm system. Each activation device has an alarm button which, when depressed, raises an alert on the alarm system. The alarm system is monitored by facility personnel/carers and indicates which user requires assistance, thereby prompting the facility personnel/carer to provide the necessary care assistance.

Known patient alarm system handset and pendant devices may function satisfactorily however, in some circumstances, known device also suffer from a number of drawbacks. For example, most activation devices comprise a housing having one central alert button and possibly additional function buttons. Where a user has low dexterity, such as an arthritis sufferer, or has low strength, such as some elderly persons, it can prove difficult or impossible to grip such an activation device and activate the alert button. Accordingly, it would be useful to provide a patient alarm system device which is able to easily be activated by a user with low dexterity and/or strength, and which is simpler to use than known devices. Furthermore, it would be advantageous to provide a solution that avoids or ameliorates any of the disadvantages present in the prior art, or which provides another alternative to the prior art approaches.

### SUMMARY OF THE INVENTION

According to one aspect of the invention there is provided an electronic activation device for a patient alarm system, the activation device comprising a resiliently deformable bladder defining an internal volume, and a pressure switch in fluid communication with the internal volume and integrated with an alarm system, whereby squeezing the resiliently deformable bladder operates the pressure switch, which activates the alarm system.

In an alternative aspect of the invention, there is provided a patient alarm system device comprising an electronic activation device having an engaging portion and a pressure switch, a resiliently deformable bladder, and alarm system integration whereby, in use, the resiliently deformable bladder is engaged with the engaging portion and squeezed, thereby operating the pressure switch and activating the alarm system.

### BRIEF DESCRIPTION OF THE DRAWINGS

Preferred embodiments of the invention will now be described, by way of example only, with reference to the accompanying drawings in which:

FIGS. 1A and 1B are front and side views (respectively) of an activation device;

FIG. 2 is a perspective exploded view of the activation device shown in FIGS. 1A and 1B;

FIG. 3 is a front cross-section view of the activation device shown in the previous figures, along line A-A in FIG. 1B;

FIG. 4A is a front view of an actuator of the activation device shown in the previous figures;

FIG. 4B is a side cross-section view of the actuator shown in FIG. 4A, along line A-A in FIG. 4A;

FIGS. 5A and 5B are front views of two alternative activation devices in use;

FIGS. 6A to 6C are front cross-section view of the activation device shown in FIGS. 1A to 4B in use;

FIG. 7 is a perspective view of three alternative activation devices having different actuators; and

FIG. 8 is a perspective view of the activation device shown in in FIGS. 1A to 4B in use.

### DETAILED DESCRIPTION OF PREFERRED EMBODIMENTS

The present disclosure relates to a patient alarm system and an electronic activation device therefor. The activation device comprises a resiliently deformable bladder defining an internal volume and a pressure switch in fluid communication with the internal volume and integrates with an alarm system, whereby squeezing the resiliently deformable bladder operates the pressure switch, which activates the alarm system. The patient alarm system comprises an electronic activation device having an engaging portion and a pressure switch, a resiliently deformable bladder, and an alarm system connected to the pressure switch, whereby, in use, the resiliently deformable bladder is engaged with the engaging portion and squeezed, thereby operating the pressure switch and activating the alarm system.

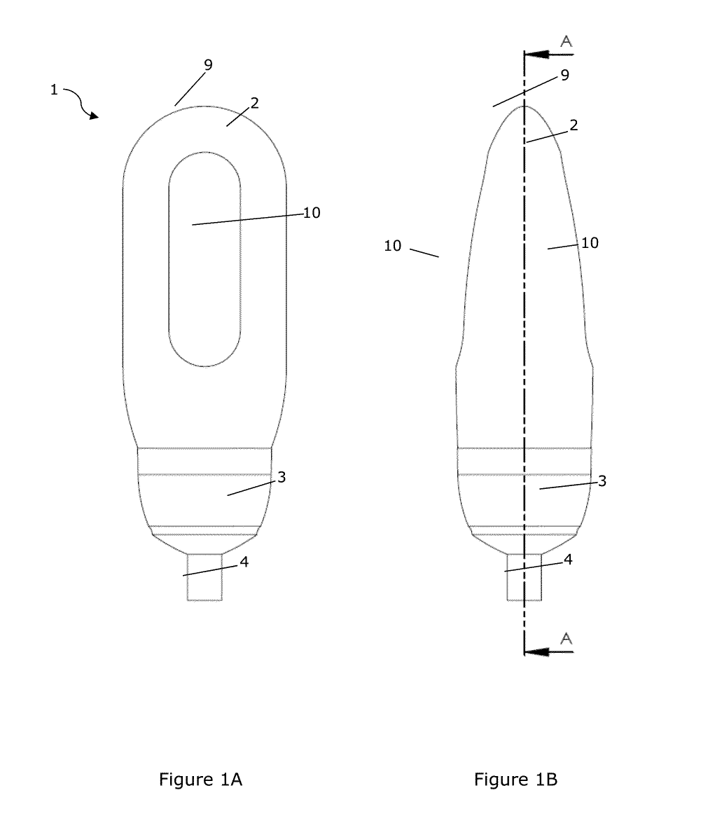

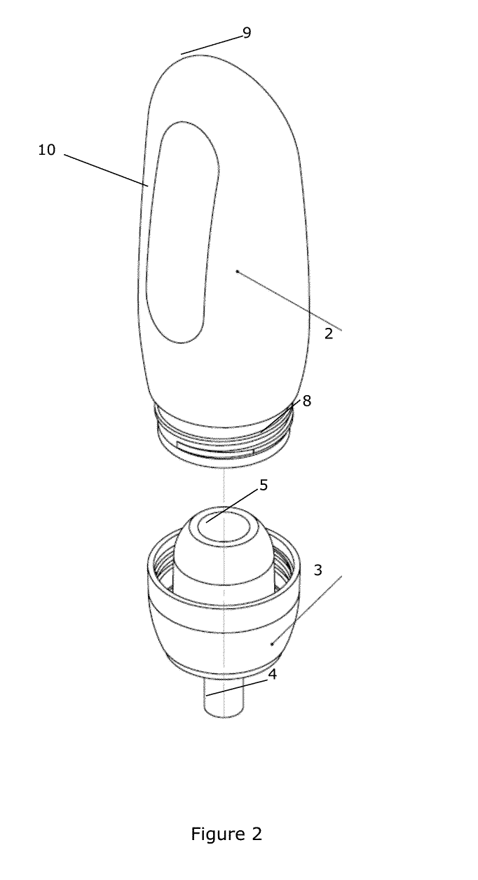

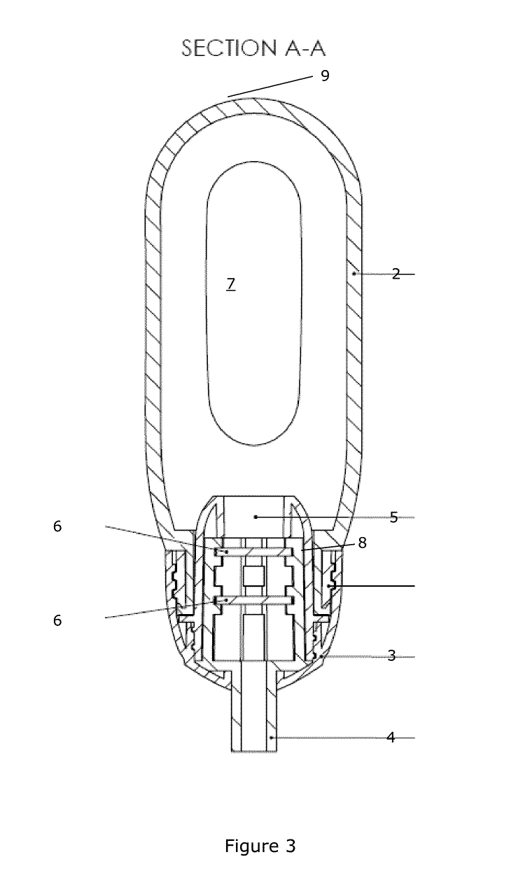

FIGS. 1A to 4B show an electronic activation device 1 for a patient alarm system (not illustrated). The device 1 comprises an actuator 2 threadedly engaged with a housing 3 and a cable 4 connected thereto. The housing 3 contains electronic components, including a pressure switch 5 and PCBs 6, which are connected to an alarm system (not shown) and power source (not shown) via the cable 4.

Optionally, the housing 3 also contains a wireless signal transmitter (not shown) and a battery (not shown). In this embodiment, the cable 4 is not necessary and omitted. The housing 3 may also be connected to a lanyard (not shown), allowing a user to wear the activation device 1 as a pendant. The housing 3 may further comprise retention means, such as a sprung clip (not shown), suction cup (not shown) and/or magnets (not shown), to releasably attach the device 1 to clothing, bedding, smooth surfaces and metal objects.

The actuator 2 is a resiliently deformable bladder defining an internal volume 7, preferably filled with air, which is in fluid communication with the pressure switch 5. The actuator 2 is sealed against the housing 3 thereby enclosing the internal volume 7. When a compressive force is applied to the actuator 2, the pressure within the internal volume 7 increases. When the pressure exceeds a threshold, the pressure switch 5 is operated, thereby activating the alarm system.

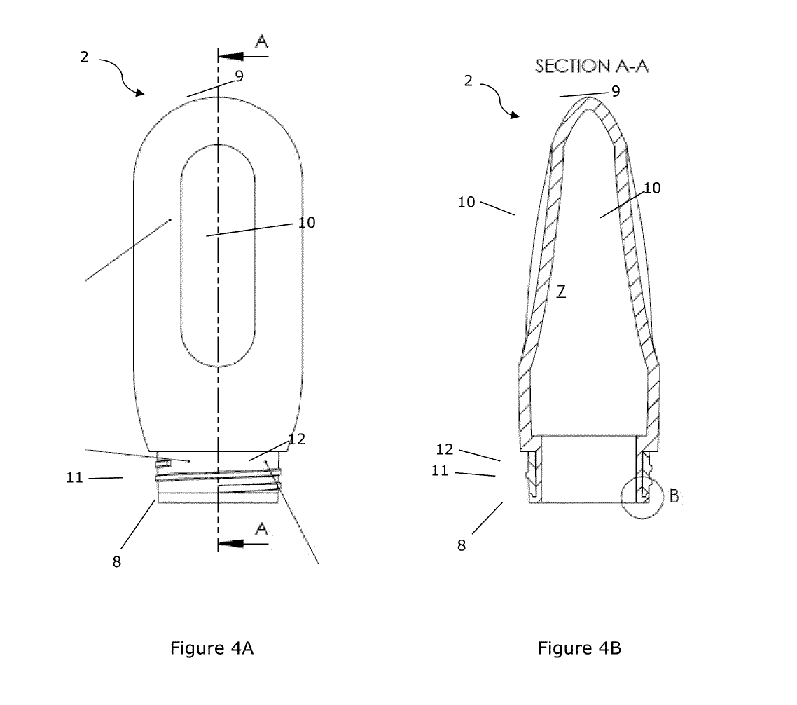

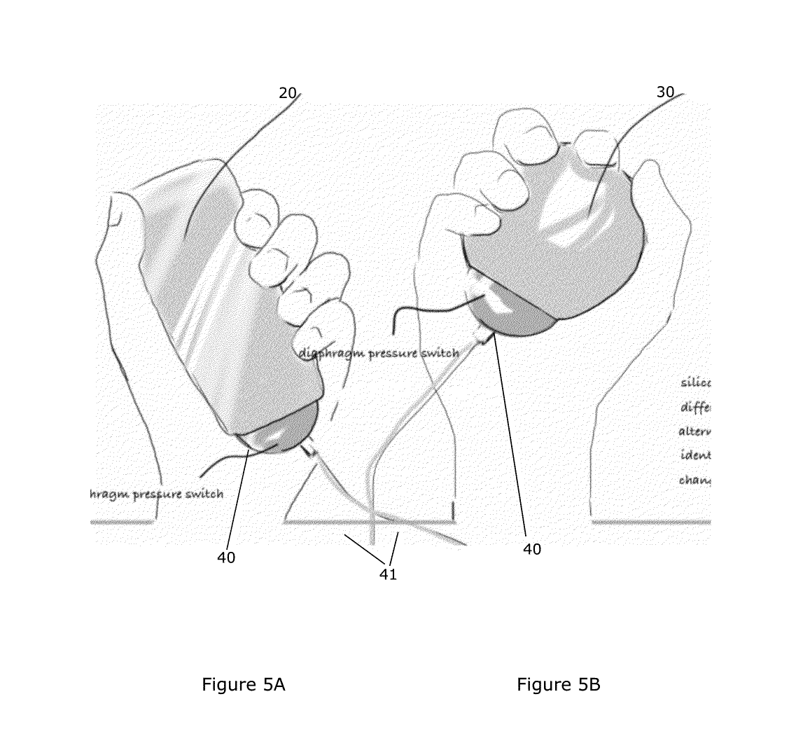

The actuator 2 is generally cylindrical, such that it is comfortable to grip in the hand of a user. The actuator 2 has a bulb-like shape, having a substantially elliptical cross-section and tapers from a first end 8, which engages the housing 3, towards a second end 9. The second end 9 is also rounded. Each side of the actuator 2 has a finger grip 10 formed from an indented groove which runs parallel to the length of the actuator 2. Whilst each finger grip 10 is configured as a groove in actuator 2, it will be appreciated that the finger grip 10 may comprise other features to assist gripping the actuator 2, such as hemispherical indentations and/or protrusions. Further, the actuator 2 is preferably formed from a synthetic rubber material to increase friction between the device 1 and a surface or user. Referring to FIG. 4B, the actuator 2 is shown in cross-section illustrating the thin walls of the bladder 2. The actuator 2 is able to be compressed with little force, preferably being between 10-15N. The force required to compress the actuator 2 is dependent on the wall thickness and/or material which the actuator 2 is formed from.

The first end 9 has a thread 11 extending therefrom to allow the actuator to engage the housing 3. The thread 11 is formed on a separate collar 12, however the thread may be integral with the actuator 2.

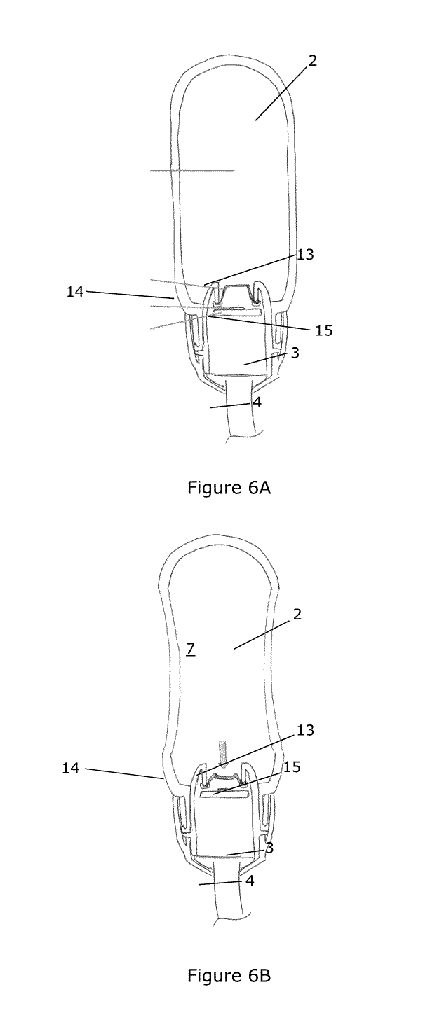

FIGS. 5A and 5B show two alternative activation devices 20, 30 in use, where each device 20, 30 is gripped in the hand of the user. Each device 20, 30 have a common base 40 which contains a pressure switch 5 and PCBs 6 as described above, and connects these components to the alarm system via a cable 41. The first device 20 has an actuator 21 having a generally flat, tablet-like shape. The second device 30 has an actuator 31 having a generally spherical shape. As the devices 20, 30 share the common base 40, the user may select which actuator 21, 31 is considers most comfortable to grip and connect this to the base 40.

It will be appreciated that the actuators 21, 31 are merely examples of many different shaped and sized actuators which may be connected to the base 40. In some instances, a bespoke actuator may be fabricated with a ‘3D printer’ having specific geometry and/or formed from specific materials according to the needs of a particular user. This may be as a result of scanning the hand of the user with a ‘3D scanner’ to determine the geometry of the actuator which would be most comfortable.

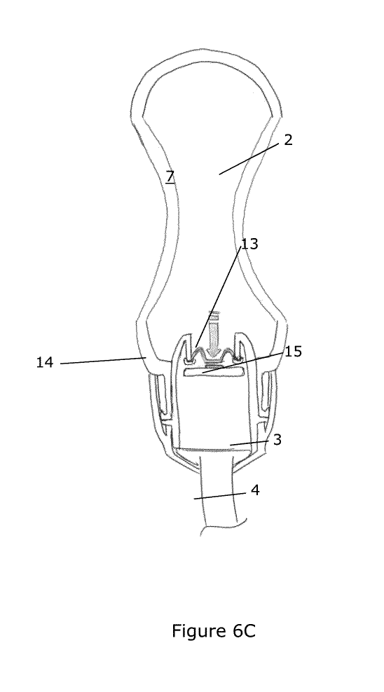

FIGS. 6A-6C illustrate three stages of operating the actuator 2 and pressure switch 5 of the activation device 1 shown in FIGS. 1A-4B. The pressure switch 5 includes a diaphragm 13 retained within the internal volume 7 by an internal housing 14 connected to the housing 3. The diaphragm 13 is positioned above a contact switch 15.

FIGS. 6B and 6C show the actuator 2 being progressively squeezed by the user, increasing the pressure within the internal volume 7 and deforming the diaphragm 13 towards the contact switch 15. When the diaphragm 13 abuts the contact switch 15 (as shown in FIG. 6C), the switch 15 is operated, activating the alarm system. The switch 15 may be operated by the diaphragm 13 having a conductive ‘pill’ contact (not shown) connected thereto, which closes a contact (not shown) on the contact switch 15, therefore completing a circuit and activating the alarm system.

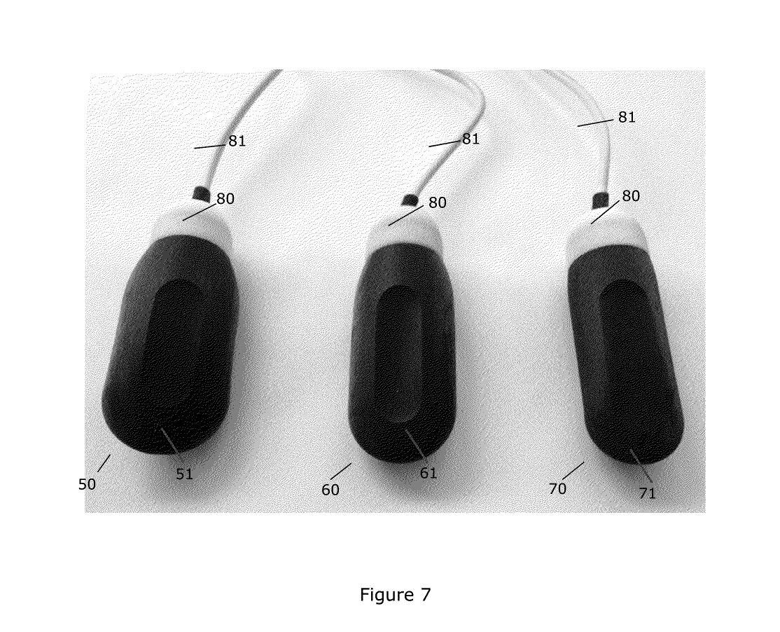

FIG. 7 shows three alternative activation devices 50, 60, 70. Each device 50, 60, 70 has a common base 80 which contains the pressure switch 5 and

PCBs 6, and is connected to the alarm system via a cable 81. The devices 50, 60, 70 each have a different actuator 51, 61, 71 having the same shape which is scaled to be larger or smaller, thereby providing a common actuator design which can be adapted to provide a comfortable fit for different user's hands. For example, the first device 50 has a ‘large’ sized actuator 51 fitted to the base 80, the second device 60 has a ‘medium’ sized actuator 61 fitted to the base 80, and the third device 70 has a ‘small sized actuator 61 fitted to the base 80. This allows a kit of bases 80 and various actuators 51, 61, 71 to be provided to a hospital or care home and for users to select the most comfortable actuator 51, 61, 71 to be fitted to their personal activation device 50, 60, 70.

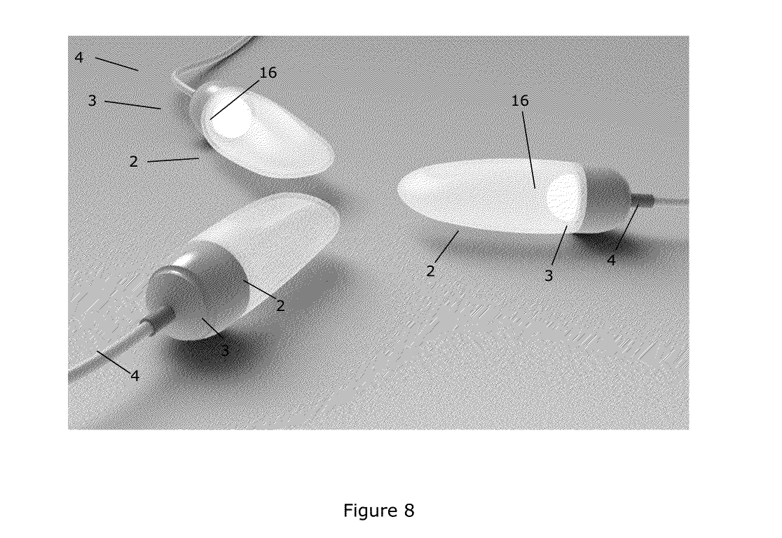

FIG. 8 show three activation devices 1 in use, after the actuator 2 has been squeezed and the alarm system activated. Each device 2 has feedback means, for providing feedback to the user to indicate the alarm system has been successfully activated. For example, the feedback means may comprise one or more of a light emitting device, speaker, buzzer or vibrator, thereby providing visible, audible and/or tactile feedback to the user.

The feedback means of the device 1 is a lamp 16, which is activated when the pressure switch 5 is operated and the alarm system activated. The lamp 16 is arranged within the internal volume 7 and the actuator is formed from a translucent or transparent material, thereby diffusing or emitting light from the lamp 16. The lamp 16 is illuminated until a carer arrives to attend the user, or for a predetermined amount of time following activation, in either case, to reassure the user they will be attended to soon. The device 1 may also have a ‘night mode’ whereby the lamp 16 is dimly lit at night in order to assist the user in locating the device 1. This may be determined by programming the lamp 16 to be dimly illuminated during specific night hours or by the device 1 also having a light dependent resistor (not shown) which automatically activates the lamp 16 when light levels fall below a threshold. The lamp 16 and/or the actuator may also be coloured in order to further assist the user in locating the device 1.

It will be apparent that obvious variations or modifications may be made which are in accordance with the spirit of the invention and which are intended to be part of the invention. Although the invention is described above with reference to specific embodiments, it will be appreciated that it is not limited to those embodiments and may be embodied in other forms.

### INDUSTRIAL APPLICABILITY

The invention can be utilised in the provision of health care and aged care.

1. An activation device for a patient alarm system, the activation device comprising:
a resiliently deformable bladder defining an internal volume; and
a pressure switch in fluid communication with the internal volume and connected to an alarm system;
whereby squeezing the resiliently deformable bladder operates the pressure switch, which activates the alarm system.

2. The activation device according to claim 1, wherein the resiliently deformable bladder is shaped to fit within a user's hand.

3. The activation device according to claim 2, wherein the resiliently deformable bladder has at least a portion which is substantially cylindrical.

4. The activation device according to claim 2, wherein the resiliently deformable bladder has at least a portion having an elliptical cross-section.

5. The activation device according to claim 1, wherein the resiliently deformable bladder has a first end and a second end, and tapers towards the second end.

6. The activation device according to claim 5, wherein the second end is rounded.

7. The activation device according to claim 1, wherein the resiliently deformable bladder has at least one finger grip.

8. The activation device according to claim 7, wherein the at least one finger grip comprises an indented groove.

9. The activation device according to claim 8, wherein the resiliently deformable bladder defines a longitudinal axis, and wherein the indented groove of the at least one finger grip is arranged parallel to the longitudinal axis.

10. The activation device according to claim 1 further comprising feedback means connected to the pressure switch, whereby operating the pressure switch activates the feedback means, providing feedback to a user.

11. The activation device according to claim 10, wherein the feedback means remains active for a predetermined time period after operating the pressure switch.

12. The activation device according to claim 10, wherein the feedback means is a light emitting device.

13. The activation device according to claim 12, wherein the light emitting device is arranged within the resiliently deformable bladder, and the resiliently deformable bladder is at least partially transparent, thereby allowing light to be emitted therethrough.

14. The activation device according to claim 1 further comprising a housing having an engaging portion for releasably engaging the resiliently deformable bladder.

15. The activation device according to claim 14, wherein the housing further comprises a retaining portion for retaining the pressure switch.

16. The activation device according to claim 1 further comprising a wireless signal transmitter, and whereby operating the pressure switch activates the wireless signal transmitter and transmits a wireless signal.

17. A patient alarm system comprising:
an activation device having an engaging portion, and a pressure switch;
a resiliently deformable bladder; and
the pressure switch integrated with an alarm system;
whereby, in use, the resiliently deformable bladder is engaged with the engaging portion and squeezed, thereby operating the pressure switch and activating the alarm system.

18. The patient alarm system of claim 17 further comprising a plurality of resiliently deformable bladders, each resiliently deformable bladder having a different shape or dimensions, whereby, in use, a user selects a preferred resiliently deformable bladder and engages the preferred resiliently deformable bladder with the engaging portion.

19. The patient alarm system of claim 18, wherein each of the plurality of resiliently deformable bladders have the same shape and are scaled to have different dimensions.

20. The patient alarm system of claim 17, wherein the resiliently deformable bladder is a bespoke shape configured to fit within a user's hand.
